(19) United States
(12) Patent Application Publication
(10) Pub. No.: US 2016/0379509 A1
(43) Pub. Date: Dec. 29, 2016

(54) SYSTEM AND METHOD FOR PREDICTING DEMAND FOR QUESTIONS OF A CATEGORY IN A COMPUTER-IMPLEMENTED QUIZ

(71) Applicant: QuizFortune Limited, Belfast (GB)

(72) Inventors: Vincent Rainey, Dunloy (GB); Andrew Bowd, Belfast (GB); Colm Hayden, Belfast (GB)

(21) Appl. No.: 14/754,466

(22) Filed: Jun. 29, 2015

(51) Int. Cl. G09B 7/00; G09B 5/02

(52) U.S. Cl. CPC G09B 7/00; G09B 5/02

(57) ABSTRACT

A computer-implemented method of managing a computer-implemented quiz in which questions are delivered to at least one player using a computer system. Questions are assigned to question categories in category hierarchies. Players can navigate through the category hierarchies to select a question category of interest. The path taken by the players through the hierarchy and the number of times the players select the question categories are recorded and analysed to detect patterns in the players behaviour. The patterns are used to predict the next question category to be selected by the players and so to determine demand for questions.

### FIELD OF THE INVENTION

The present invention relates to computer-implemented quizzes, particularly on-line quizzes. The invention relates especially to predicting demand for questions of a category in a computer-implemented quiz.

### BACKGROUND TO THE INVENTION

A problem with providing computer-implemented quizzes is that questions need to be authored in advance of when they are needed, yet peak demand for questions of a particular category is sometimes driven by conditions that are hard to predict.

It would be desirable therefore to provide a method and system that can give advance notice of demand for questions of a category to enable additional questions to be authored in time for the future demand.

### SUMMARY OF THE INVENTION

A first aspect of the invention provides a computer-implemented method of managing a computer-implemented quiz in which questions are delivered to at least one player using a computer system, the computer system comprising at least one server computing device in communication with at least one client computing device across a telecommunications network, the method comprising operating said computer system to:

store data defining at least one category hierarchy, said at least one category hierarchy comprising a top level and at least one subordinate level including a lowest level, said top level including a top level hierarchy element corresponding to a main category topic, said at least one subordinate level including at least one respective subordinate hierarchy element corresponding to a respective sub-category topic, and wherein said lowest level includes at least one subordinate element corresponding to a respective one of a plurality of question categories;

assign each of said questions to at least one of said question categories;

maintain, in respect of said at least one question categories, at least one set of at least one of said questions assigned to the respective question category;

present, at said at least one client computing device, a user interface providing an interactive representation of said at least one category hierarchy;

record, at said at least one client computing device, path data indicative of a path taken by a player through a selected one of said at least one category hierarchy using said interactive representation and said user interface;

maintain, in respect of said at least one player, a play history record including said path data and data indicating the number of times said at least one player has selected each of said question categories;

analyse, in respect of said at least one player, the respective play history record to detect at least one pattern in said at least one player's interaction with the system;

determine, in respect of said at least one player, at least one predicted next question category using said at least one pattern; and

compare, in respect of said at least one predicted next question category, the respective play history record for the respective player and said at least one set of questions assigned to the respective question category to determine a demand for questions in the respective question category.

At least some of said questions are preferably assigned to a plurality of said question categories.

Preferably, at least some of said questions are assigned to at least one of said question categories so that said at least some of said questions are associated with a plurality of said subordinate elements of at least one of said category hierarchies.

In preferred embodiments at least some of said question categories are selectable, by said player using said interactive representation and said user interface, by any one of a plurality of said paths through at least one of the or each category hierarchy.

Typically, there are a plurality of players, said method further including determining either or both of the number or percentage of said players selecting said at least one predicted next question category, and/or determining either or both of the number or percentage of said players selecting said main category topic, and/or determining either or both of the number or percentage of said players selecting said at least one subordinate category topic, and/or determining either or both of the number or percentage of said players repeatedly selecting said at least one predicted next question category, and/or determining either or both of the number or percentage of said players repeatedly selecting said main category topic, and/or determining either or both of the number or percentage of said players repeatedly selecting said at least one subordinate category topic.

Preferably, the method includes defining said at least one hierarchy so that at least one player selectable path through at least two of said at least one category hierarchies includes at least one sequence of at least two of said topics, more preferably including defining said at least one hierarchy so that at least one player selectable path through at least two of said at least one category hierarchies includes at least one reverse sequence of said at least two of said topics.

Preferably, the method includes defining said at least one hierarchy so that at least two player selectable paths through at least one of said at least one category hierarchies includes at least one sequence of at least two of said topics, more preferably defining said at least one hierarchy so that at least two player selectable paths through at least one of said at least one category hierarchies includes at least one reverse sequence of said at least two of said topics.

In preferred embodiments there is a plurality of players, and determining said demand for questions is performed by analysing the respective play history of each of said players.

Preferably, said analysing the respective play history record to detect at least one pattern involves detecting, in at least one of said paths, repeated sequences of two or more topics or types of topics.

Preferably, said analysing the respective play history record to detect at least one pattern involves detecting, in at least one of said paths, relationships between two or more topics, or types of topic.

Preferably, said analysing the respective play history record to detect at least one pattern involves detecting, in at least one of said paths, repeated selection of any one of said subordinate category topics after different category topics associated with a superior level in the respective category hierarchy.

A second aspect of the invention provides a computer system for managing a computer-implemented quiz in which questions are delivered to at least one player, the computer system comprising at least one server computing device in communication with at least one client computing device across a telecommunications network, the system including computer software configured to operate said computer system to:

store data defining at least one category hierarchy, said at least one category hierarchy comprising a top level and at least one subordinate level including a lowest level, said top level including a top level hierarchy element corresponding to a main category topic, said at least one subordinate level including at least one respective subordinate hierarchy element corresponding to a respective sub-category topic, and wherein said lowest level includes at least one subordinate element corresponding to a respective one of a plurality of question categories;

assign each of said questions to at least one of said question categories;

maintain, in respect of said at least one question categories, at least one set of at least one of said questions assigned to the respective question category;

present, at said at least one client computing device, a user interface providing an interactive representation of said at least one category hierarchy;

record, at said at least one client computing device, path data indicative of a path taken by a player through a selected one of said at least one category hierarchy using said interactive representation and said user interface;

maintain, in respect of said at least one player, a play history record including said path data and data indicating the number of times said at least one player has selected each of said question categories;

analyse, in respect of said at least one player, the respective play history record to detect at least one pattern in said at least one player's interaction with the system;

determine, in respect of said at least one player, at least one predicted next question category using said at least one pattern; and

compare, in respect of said at least one predicted next question category, the respective play history record for the respective player and said at least one set of questions assigned to the respective question category to determine a demand for questions in the respective question category.

Other preferred aspects of the invention will be apparent to those ordinarily skilled in the art upon review of the following description of a specific embodiment and with reference to the accompanying drawings.

### BRIEF DESCRIPTION OF THE DRAWINGS

An embodiment of the invention is now described by way of example and with reference to the accompanying drawings in which:

FIG. 1 is a block diagram of a computer-implemented system embodying one aspect of the present invention, the system being operable to provide an on-line quiz; and

FIG. 2 is a flow chart illustrating the preferred operation of the system of FIG. 1;

FIG. 3 is a schematic illustration of a category hierarchy; and

FIGS. 4A to 4D provide an illustration of how a category hierarchy may be displayed to a player.

### DETAILED DESCRIPTION OF THE DRAWINGS

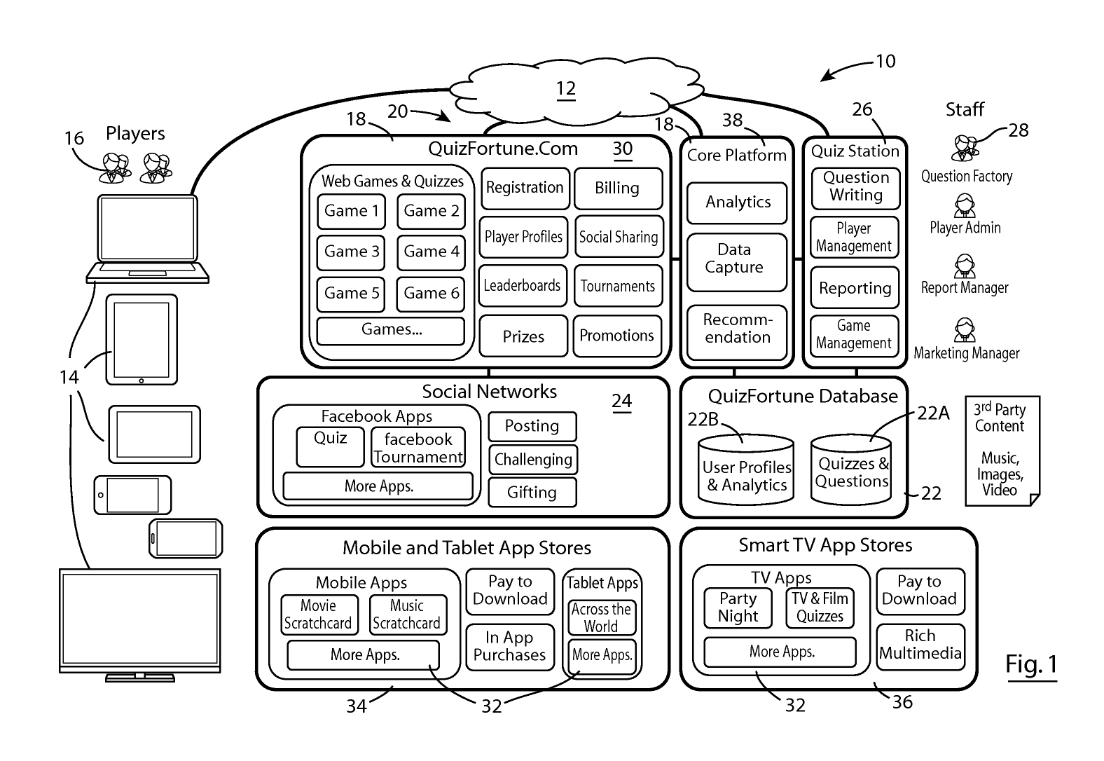

Referring now to FIG. 1 of the drawings there is shown, generally indicated as 10, an embodiment of a computer-implemented system that is operable to provide one or more quizzes, in particular an on-line quiz. The system 10 comprises a plurality of computing devices in communication with one another via a telecommunications network 12, typically comprising any one or more of the internet, a telephone network (e.g. public standard telephone network and/or cellular network) and/or one or more computer networks, any part of which may be wired or wireless as applicable. The computing devices comprise computer hardware supporting the operation of computer software to enable the system 10 to perform the operations described herein, or variations thereof. Other than as described herein, the computer hardware and software may be conventional.

The computing devices include at least one, but typically a plurality of, client computing devices 14, which may for example be a laptop computer, a personal computer, a smart television, or a mobile computing device such as a smart telephone, a tablet computer, a smart watch or a personal digital assistant. Each client computing device 14 is used by one or more player 16 to participate in one or more quizzes provided by the system 10. The client computing devices 14 include computer software to enable the client device 14 to operate and the player 16 to interact as described herein. The computer software may for example comprise a dedicated application (e.g. a mobile application or tablet application) or a web browser for running a web-based application.

The computing devices include at least one server computing device 18 which may comprise any suitable computer hardware supporting server software for providing services to the client devices 14 across the network 12. The server software may for example enable the server device(s) 18 to act as any one or more of a web server, database server, file server, gaming server or application server as applicable.

In the illustrated embodiment, the system 10 comprises a computing platform 20 for the delivery and management of quizzes, especially trivia-based quizzes, which is implemented by one or more server devices 18 as is convenient. The preferred computing platform supports computer software providing the following system components:
A database 22 (or other computer-implemented data storage facility)—the database stores all information generated by players 16 acting on the platform 20, including questions and quizzes, scores recorded by players 16, and analytics calculated by one or more components of the platform 20 based on recorded player behaviour. Typically, there are two logical databases (or other computer-implemented data storage facility):
   a database 22A for storing quizzes and questions—this is typically a read-mostly database that stores the questions and answers comprising the quiz, along with metadata that categorises and tags the questions and quizzes;
   a database 22B for storing player profiles and analytic data—this is typically a write-mostly database that records profile information entered by players during registration or collected from other sources, for example from a social networking computing platform 24, e.g. from Facebook (Trade Mark) during a sign in, along with all of the answers and timings recorded after a player has played a quiz;
a management component 26 (designated “QuizStation” in FIG. 1)—this is conveniently a web application (although it may implemented in any convenient manner) and comprises a content management software engine for the questions and quizzes. This component enables authorised user(s) 28, e.g. a question authoring team, to write questions, categorise and tag the questions and group the questions into quizzes. The questions and quizzes, together with any associated information (e.g. metadata), may then be stored in the database 22A. Quizzes can then be further categorised into quiz packs. The quizzes/quiz packs are made available to the players 16 in any convenient manner, e.g. published to the mobile or tablet applications or to a website 30. The management component 26 may also enable the authorised users 28 to perform other administrative, reporting or marketing tasks;
a website 30 (designated “QuizFortune.com” in FIG. 1)—the website 30 comprises one or more web applications for providing players 16 with the ability to play web-based quizzes, register, and sign in to view and manage their public user profile, using a web browser running on their client device 14;
one or more downloadable client applications 32 (shown in FIG. 1 as being available from a mobile and tablet “app store” 34 or a smart TV “app store” 36). These are typically dedicated mobile, table or smart TV applications that are downloadable by the client devices 14 to enable the players 16 to participate in the system 10.
A core platform component 38—this supports server software and may for example be implemented as a plurality of stateless HTTP REST web services. The various web applications of the website 30 and the management component 26, and the client applications 32 are configured to interface with the core platform 38, preferably to provide the following functionality:
   data capture: this involves the collection of statistics, in particular recording the scores submitted from the web and mobile applications 30, 32 after a quiz has been played.
   analytics: this involves analysing the recorded player statistics using one or more analytical computer-implemented services to, for example, identify patterns, generate leaderboards and rank the players according to their skill level on the quizzes they have played.
   recommendation: this involves providing various content recommendations. A particular example is a 2-player asynchronous mode ‘bot service’ which determines for a particular player and quiz whether a ‘bot’ (a simulated artificial intelligence player) or a ‘ghost’ (previously recorded answers and timings for a player playing the same quiz) is available, and deciding the skill of the bot or ghost for the real player to play against.

Operation of the preferred systems 10 is now described, particularly with regard to predicting demand for questions of a category in a computer-implemented quiz. In this connection, the following definitions are adopted:
Player: a user 16 who selects a quiz and plays the quiz by answering questions one at a time
Player Profile: a user profile, provided to the system 10 by the user 16 and/or observed by the system 10, comprising computer usable data that identifies the player 16 as belonging to a particular player segment, which may be defined by one or more sociological and/or demographic factors (e.g. age, gender, nationality, place of residence) and/or other user-specific characteristics such as quiz-related data (e.g. data indicative of the number of quizzes in which the player has participated, the frequency with which the player participates in quizzes, and or the player's performance in the quizzes. For example, a player profile might contain data indicating that the player lives in the USA, is male, 24 years old, has played 200 quizzes, averaging 3 quizzes a day, and answering 60% of questions correctly.
Quiz: A named collection of questions, on a common topic, served one question at a time to a player 16.

Question: a question, preferably a multiple choice trivia question, comprising a Correct Answer and a plurality of Wrong Answers, and preferably a prompt, all being in computer usable form.
Correct Answer: the single correct answer to a question
Wrong Answers: multiple wrong answers presented alongside the correct answer as possible choices to the player 16.
Play: A particular instance of a play of a quiz by a player 16. A player can play the same quiz multiple times resulting in multiple plays.
Recorded Answer: the recorded choice of answer for a player 16 to a particular play of a particular quiz.
Category: a grouping of questions under a common topic.
Taxonomy: the complete collection of all categories used to classify questions. Note that a question may exist in one or more categories.

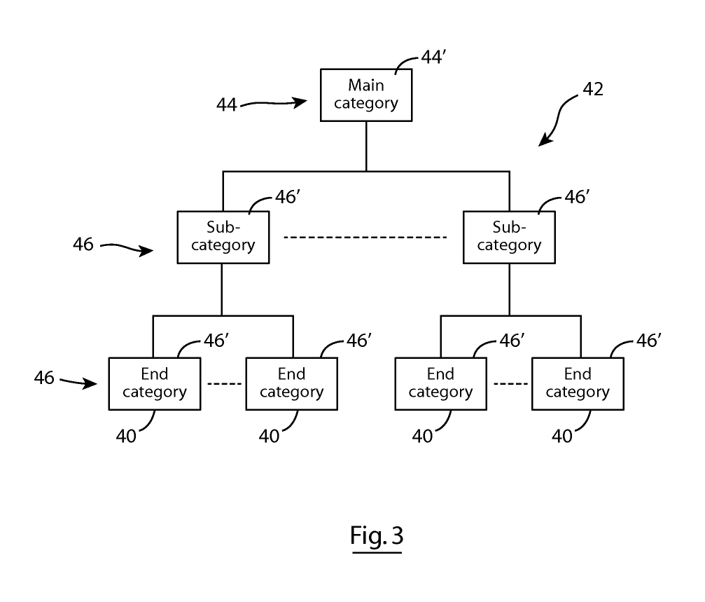

With reference to FIG. 3, each category 40 is included one (or more) category hierarchy 42 that has multiple levels including a top level 44 and one or more successive subordinate levels 46. In the top level there is usually only one hierarchy element 44′, which corresponds to a main category topic. The, or each, subordinate level may include one or more hierarchy elements 46′, each corresponding to a respective sub-category topic that is related to the respective topic of the preceding hierarchy element 44′, 46′ in the directly superior level of the hierarchy. The categories 40 typically correspond to the hierarchy elements 46′ at the lowest level of the hierarchy 42 and are associated with one or more respective quizzes that can be presented to a player 16, each quiz comprising questions relevant to a respective end category topic. Hence, each category 40 can be associated with a category path through the hierarchy 42, the path comprising a hierarchical sequence of related topics, i.e. a main category topic, an end category topic and, depending on the number of levels in the hierarchy 42, one or more intermediate sub-category topics.

Optionally, only the lowest level in the hierarchy contains questions that can be presented to a user, i.e. that the player cannot stop the question selection process at an intermediate level in the hierarchy and have questions delivered to him. In alternative embodiments, the hierarchy may be configured to allow the user to select to have questions delivered from any level of the hierarchy not just the lowest level.

Examples of category paths are given below for a taxonomy comprising three category hierarchies 42 having the main category topics “Film”, “History” and “Music” at their respective top levels:
Film>Action>James Bond
History>20^{th} Century>Europe
History>Europe>20^{th} Century
Music>Rock Music>Glam Rock
Music>Soundtracks

The category 40 with the topic of “James Bond” has a category path comprising the main category topic “Film”, the sub-category topic “Action” and the end category topic “James Bond”. Similarly the category 40 with the topic of “Glam Rock” has a category path comprising the main category topic “Music”, the sub-category topic “Rock Music” and the end category topic “Glam Rock”, while the category 40 with the topic of “Soundtracks” has a category path comprising the main category topic “Music”, and the end category topic “Soundtracks” with no intermediate sub-categories.

It will be understood that any given topic may be associated with the respective elements 44′, 46′ of more than one level in the hierarchy 42, although typically not in any direct path through the hierarchy 42. In the example above, the topic “Europe” is an end category topic for one path through the “History” hierarchy 42 and a sub-category topic for another path through the same hierarchy. Topics can also appear in more than one hierarchy.

In preferred embodiments, the taxonomy of categories may comprise one or more category hierarchies 42, each hierarchy 42 having typically two or more levels, each level comprising one or more hierarchy elements. More particularly each category path through a hierarchy 42 may comprise two or more levels, and different paths through a hierarchy need not necessarily have the same number of levels.

In preferred embodiments, operation of the system 10 is predicated around the following principles:
1. Allowing questions to be included in more than one category 40 enables the system 10 to monitor a player's approach to choosing a category. By organising questions into categories 40 within one or more hierarchy, and allowing the same question to appear in multiple categories 40 (e.g. in one or more quizzes that appear in more than one category 40), a user can be provided with multiple paths through one or more hierarchy 42 to reach the same question. For example, the same question may appear in the category “Europe” by the following path Geography−>Lakes−>Europe and in the category “Lakes” by the following alternative path Geography−>Europe−>Lakes. By enabling users to browse from the generic to the specific by selecting a main category topic, then exploring into one or more related sub category topic, the system 10 can recording the path taken, in order to understand the player's train of thought.
2. By supporting repeat play the system 10 can determine how many times a player 16 will play a category 40 of quiz before moving to another category 40. By populating each player-selectable category 40 with enough questions for repeat play, the demand for a particular category 40 (and for the related main category and sub-category topics) can be determined by either or both the number or percentage of players 16 selecting that category 40 (and/or the related main category and sub-category topics), and the number or percentage of players repeatedly requesting that category 40 (and/or the related main category and sub-category topics), and/or the number of times each player 16 repeats play of a category. Such statistics can be averaged over all players or a group of players. For example, it might be determined that on average players 16 will play ‘History−>20^{th} Century>Europe’ 3 times before moving to another category, but will play Film>Action>James Bond 8 times before moving to another category.
3. By repeating one or more sequences of two or more topics in one or more paths through one or more hierarchy 42, a player's behaviour can be better understood by the system 10, particularly if one or more paths with a respective reverse sequence of topics is also provided. In preferred embodiments, a sequence of two or more topics is included in at least one path through at least two category hierarchies 42. Preferably, the respective reverse sequence of the same topics is included in at least one path in each hierarchy 42. Hence, when moving through a hierarchy 42, the player 16 is faced with choosing the same topic at different levels of the hierarchy depending on what was chosen at the previous level.
For example, considering the generic paths:
   ‘[Main Category topic]>[Century]>[Region]’ and
   ‘[Main Category topic] >[Region] >[Century]’
Where the sequence of the topics “Century” and “Region” appears in forward and reverse order in respective paths through the same hierarchy 42. If this is applied by way of example to two different category hierarchies 42 with main category topics ‘History’ and ‘Art’ respectively, the following paths could be provided:
   ‘History>20^{th} Century>Europe’ and
   ‘History>Europe>20^{th} Century’ and
   ‘Art>20^{th} Century>Europe’ and
   ‘Art>Europe>20^{th} Century’
The system 10 could for example detect a common behaviour that one or more player first explores (or tends to explore) by Region, then by Century starting with the most recent. This allows the system 10 to predict subsequent player choices. For example, observing the following succession of paths being chosen:
   ‘History>Europe>21^{st} Century’
   ‘History>Europe>20^{th} Century’
   ‘History>Europe>19^{th} Century’
   ‘Art>Europe>21^{st} Century’
‘Art>Europe>20^{th} Century’
may cause the system 10 to determine that the next category path, and therefore category 40, would be:
   ‘Art>Europe>19^{th} Century’
4. By recording category paths, category demand (number of repeat requests/plays for a category) and analysing successive category paths followed by any given player 16, the system 10 can predict demand for questions of a particular category. The system 10 can therefore determine which categories are in demand (and need more questions to allow further repeat play) and suggest new categories in respect of which questions need to be authored. Such analysis can be performed on a per player basis and/or across multiple players. When performed across multiple players the analysis can be calculated cumulatively and/or as an average.

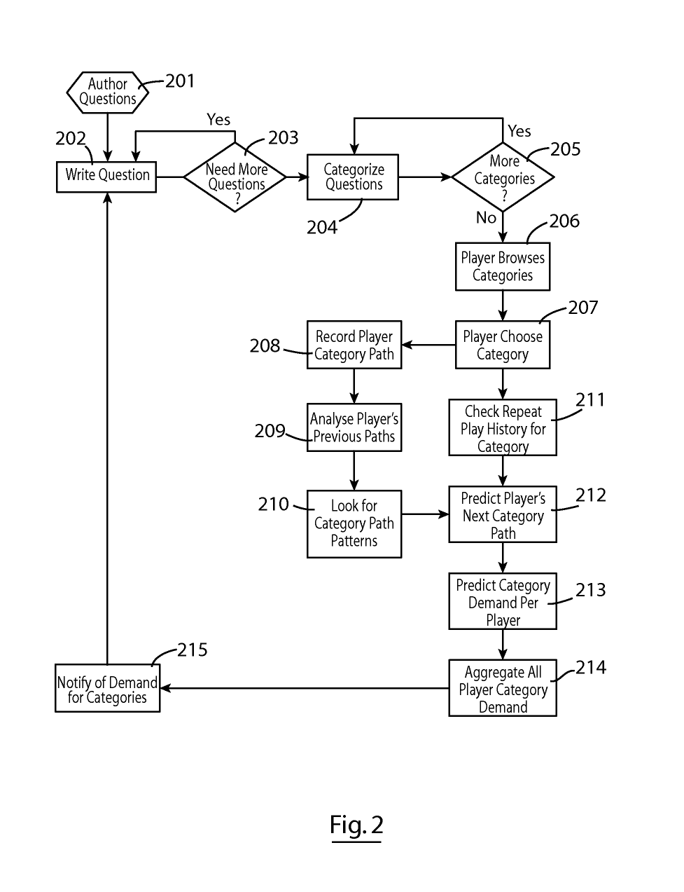

FIG. 2 illustrates an example of the operation of the preferred system 10, which involves predicting the demand for questions of a category.

In process steps 201 to 203 questions are created, where each question preferably comprises the question itself, the correct answer and multiple wrong answers, preferably more wrong answers that are provided to a player 16 during play. This may be done by one or more users 28 via the management component 26, the questions and any associated metadata being stored in database 22A in computer usable form. For example, an authorised user 28 logs into the management component 26 to write questions (201). Using a question authoring function supported by the component 26, the user 28 creates a question by entering the question, the correct answer and multiple wrong answers, typically between 3 and 5 wrong answers (202). Advantageously more wrong answers are entered than are presented to a player when the question is rendered during play to allow permutations of the question with varying degrees of difficulty to be presented. The user 28 may provide ranking data to the component 26 for association with the question (e.g. as metadata), the ranking data ranking the wrong answers in order of likelihood that a player might believe them to be correct. Using a save question function supported by the component 26, the question, correct answer and set of wrong answers are written to the database 22A with any associated metadata (202). Preferably, for each question, multiple instances of the question are stored in the database 22A, each instance having a respective different combination (or permutation) of wrong answers. The multiple instances are associated with respective ranking data or other metadata that is indicative of the relative difficulty of the respective instance compared to the other instances of the same question. Hence, the question is stored as a set of multiple variations of the question that are ranked in order of difficulty. This may be performed by the user 28 and/or by the component 26 as is convenient. When this is performed during question authoring (e.g. during step 202), the difficulty order may be determined using the ranking applied by the user 28, resulting in an initial answer combination difficulty order. The system 10 may associate one or more other answer combination difficulty orders with the set of questions, for example a respective difficulty order for multiple different player profile types, e.g. where the difficulty order is associated with one or more sociological and/or demographic characteristics that may be found in player profiles. This is typically performed by the system 10 using statistics gathered by the core platform component 38 from use of the system 10 by multiple players 16 with similar or different player profile types as applicable, the difficulty orders being stored in the database 22.

The question authoring process may be repeated until a desired number of questions are created (203).

At steps 204 and 205, the user 28 categorises the, or each, question by assigning it to one or more categories 40, where each category relates to a respective topic with which the question may be associated. Any category to which the question is assigned may be at any level in the hierarchy 42. In the preferred embodiment, each question is assigned to one or more categories 40 that allow it to be grouped with other like-category questions to form one or more quizzes. The assignable categories 40 may for example relate to any of the end category topics described above with reference to FIG. 3, 15 and/or any of the sub-category topics and/or main category topics. Optionally each question is stored in association with metadata indicating the, or each category, to which it has been assigned.

Each question may also be tagged with a tag, which may for example comprise free form metadata, that can be used in addition to categorisation. The purpose of tagging is predominantly to support contextualised search by the question authors, while categories are used by both authors and players to browse for questions.

One or more quizzes are created using the categorised questions in the database 22A. This may be performed by the user 28, or another user 28, via the management component 26. Each quiz typically includes multiple questions, and creating a quiz involves grouping a plurality of the questions using the management component 26. In preferred embodiments, the questions in each quiz share at least one common category 40. The groupings may be recorded as metadata associated with the respective questions and may be stored in the database 22A. In cases where multiple instances of each question are stored, each instance is preferably included in the quiz group.

Each quiz is associated with one or more category 40 (corresponding to the, or each, respective category of the respective questions of the quiz), as may for example be indicated by metadata associated with the quiz. Data defining the or each category hierarchy 42 supported by the system 10 is conveniently stored in the database 22, e.g. in database 22A, typically having been created by a user 48 via the management component 26. Accordingly, using the category hierarchy data and the quiz category data, the system 10 (conveniently the core component 38) associates each quiz with one or more element 46′ of one or more hierarchy 42, usually elements 46′ corresponding to the lowest level in the hierarchy 42. Hence, when a player 16 selects a category 40 from a category hierarch 42, the system 10, and particular the core component 38, can identify which quiz(es) are available for presentation to the player 16 for the selected category 40.

During use, when a player 16 instantiates a downloadable application 32 or web application via the website 30, the instantiated application requests currently available quizzes from the core platform component 38, in response to which the core component 38 causes the requested quizzes to be communicated to the respective client device 14 across the network 12 together with any associated metadata and the data defining the or each category hierarchy 42. The instantiated application displays the quizzes to the player 16 on the display of the client device 14. In preferred embodiments, the instantiated application displays to the player 16 the, or each, category hierarchy 42 defined by the received category hierarchy data in a player-interactive form, i.e. such that the player 16 is able to browse or navigate through the, or each, hierarchy 42 by making selections at the various levels of the hierarchy.

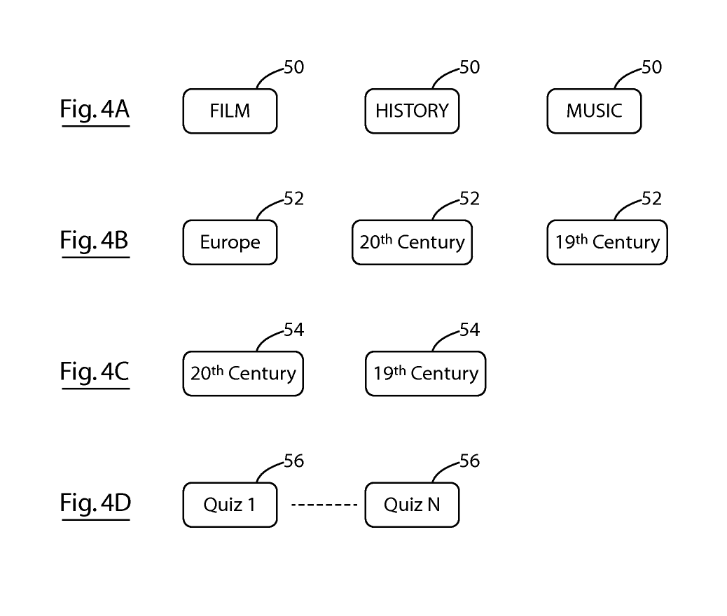

Referring to FIG. 4A, this preferably involves displaying a respective player-selectable icon 50 corresponding to the respective top level element 44′ of each hierarchy. In the illustrated example, it is assumed that there are three hierarchies whose top level elements 44′ correspond respectively to the main category topics “Film”, “History” and “Music”. In response to the player 16 selecting one of the displayed icons 50, the instantiated application displays a respective player-selectable icon 52 corresponding to the respective element 46′ of the next level in the respective hierarchy 42. In the illustrated example it is assumed that the player 16 has selected the “History” icon 50 and is subsequently presented with a respective selectable icon 52 for “Europe”, “20^{th} Century” and “19^{th} Century”, which are assumed in this example to be the sub-category topics corresponding to the elements 46′ in the next level of the selected hierarchy 42 (FIG. 4B). This process is repeated until the lowest level of the hierarchy is reached. In the illustrated example, it is assumed that there is a further level in the selected hierarchy. Therefore, in response to the player 16 selecting one of the displayed icons 52, the instantiated application displays a respective player-selectable icon 54 corresponding to the respective element 46′ of the further level in the respective hierarchy 42. In the illustrated example it is assumed that the player 16 has selected the “Europe” icon 52 and is subsequently presented with a respective selectable icon 54 for “20^{th} Century” and “19^{th} Century”, which are assumed in this example to be the sub-category topics corresponding to the elements 46′ in the further level of the selected hierarchy 42 (FIG. 4C).

Once the lowest level in the hierarchy 42 is reached (which in this example is assumed to be the level shown in FIG. 4C), in response to the player 16 selecting one of the displayed icons 54, the instantiated application displays a respective player-selectable icon 56 corresponding to the, or each quiz, that is associated with the selected element 46′ in the lowest level of the hierarchy (and therefore also with the category 40 associated with that selected element 46′). In the illustrated example it is assumed that the player 16 has selected the “20^{th} Century” icon 54 and is subsequently presented with a respective selectable icon 56 for N quizzes.

In response to the player 16 selecting the icon 56 for a quiz, the instantiated application presents the questions of the quiz to the player 16, typically one at a time. The questions are typically multiple choice questions, the instantiated application displaying a respective player-selectable icon (not illustrated) for each selectable answer to the question.

Hence, the instantiated application allows the player 16 to navigate through one or more category hierarchies 42 and to select a category 40 corresponding to a topic of interest, and subsequently to select a quiz to play (steps 206 and 207 in FIG. 2).

The system 10, records the player's 16 interaction with the system 10, in particular recording the selected category 40 and the path through the respective hierarchy 42 that the player took to reach the selected category 40 (208). The path data typically includes data identifying the respective topic associated with each selection made by the player 16. Conveniently, the instantiated application performs this task by monitoring the icons 50, 52, 54 selected by the player 16. The instantiated application communicates data to the core platform 38 that is indicative of the selected category 40 and the path through the respective hierarchy 42. This data is stored in the database 22. It may for example be stored as metadata associated with the respective selected category (e.g. in database 22A) and/or in the player profile of the respective player 16 (e.g. in database 22B).

The system 10, typically the core component 38, analyses the data that has been stored for the player 16 identifying paths that have been taken by the player 16 when navigating through the hierarchies 42, the analysis including looking up the player's previous paths (209) and identification of patterns in the data (210). The pattern identification may for example involve detection of repeated sequences of two or more topics (or types of topics) and/or relationships between two or more topics, or types of topic, relating either to the individual paths selected by the player 16, and/or across two or more successive paths selected by the player 16, including for example similarities in parent topic to child topic sequences (e.g. when the same or a similar child topic is selected from different parent topics)

The system 10, conveniently the core component 38, records data indicating how many times the player 16 (and other players 16) selects any given category 40. Using this data the system 10 maintains data representing a repeat play history for each category 40. The repeat play history may include the number and/or percentage of players 16 selecting the respective category 40 (and/or the related main category and sub-category topics), the number and/or percentage of players 16 repeatedly selecting the category 40 (and/or the related main category and sub-category topics), and/or the number of times each player 16 repeats play of the category 40. Such statistics can be averaged over all players or a group of players.

At step 211, the system 10, typically the core component 38, checks the repeat play history of the selected category 40.

At step 212, the system 10, typically the core component 38, determines and records at least one predicted next category 40 for the player 16, i.e. one or more category 40 that the system 10 expects the player 16 to select next. Advantageously, this is achieved using the data obtained in steps 209, 210 and 211. In the example provided above, the predicted next category 40 is 19^{th} Century European Art, based on the detected pattern in the player's recorded path data that the player 16 tends to navigate through a hierarchy 42 from a region topic to a century topic, and that in successive selected paths the player 16 tends to begin with more recent centuries and then select less recent centuries. It will be apparent that the system 10 may detect any other sequence of, or relationship between, topics/types of topic other than relating to regions and centuries.

At step 213, the player's 16 demand for the categories is determined, particularly in respect of the, or each, predicted category 40 determined at step 212. The demand may be determined for one or more category in addition to the predicted category 40. For example, the demand may be determined for one or more category with a respective confidence level assigned to each category.

Determining demand may involve comparing the, or each, predicted category 40 against the player's play history (which may be included in the respective player profile and maintained using the data recorded by the instantiated application) to determine if additional quizzes/questions in the relevant categories are required. For example, if the player 16 has already played the predicted category 40 five times and there are currently only five quizzes associated with the category, then it may be determined that there is a demand for more quizzes for the category. At step 213, the demand for quizzes and/or questions in one or more categories is aggregated across all, or at least multiple, players 16.

At step 215, the system 10, typically the core component 38, provides a notification to the management component 26 identifying any categories 40 in respect of which additional questions or quizzes are required. The management component 26 provides a corresponding notification to one or more of the users 48.

Steps 209 and 215 are not necessarily performed in real time as the player 16 is playing a quiz—they may be performed at any time by the system 10. Moreover, they may be performed in respect of all players 16, or at least multiple players 16.

It will be apparent from the foregoing that the preferred system 10 is capable of predicting the demand for questions in one or more categories and notifying the users 48 so that more questions can be authored, and quizzes created, in the relevant categories.

It will be understood that what has been described herein is an exemplary computer system for implementing a quiz. While the present teaching has been described with reference to exemplary arrangements it will be understood that it is not intended to limit the teaching to such arrangements as modifications can be made without departing from the spirit and scope of the present teaching.

It will be understood that while exemplary features of a computer-implemented quiz system in accordance with the present teaching have been described that such an arrangement is not to be construed as limiting the invention to such features. The method of the present teaching may be implemented in software, firmware, hardware, or a combination thereof. In one mode, the method is implemented in software, as one or more executable program, and is executed by one or more special or general purpose digital computer(s), such as a personal computer (PC; IBM-compatible, Apple-compatible, or otherwise), personal digital assistant, workstation, minicomputer, or mainframe computer. The steps of the method may be implemented by a server or computer in which the software modules reside or partially reside.

All of the data used by the system 10, including the questions, answers, selected path data and player profiles, is provided in any conventional electronic or otherwise computer usable form.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the method as described above. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions.

Memory is associated with processor(s) and can include any one or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s). The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present teaching may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer readable medium for use by or in connection with an instruction execution system,

apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical

functions or steps in the process, as would be understood by those having ordinary skill in the art.

It should be emphasized that the above-described embodiments of the present teaching, particularly, any “preferred” embodiments, are possible examples of implementations, merely set forth for a clear understanding of the principles. Many variations and modifications may be made to the above-described embodiments.

The invention is not limited to the embodiment(s) described herein but can be amended or modified without departing from the scope of the present invention.

1. A computer-implemented method of managing a computer-implemented quiz in which questions are delivered to at least one player using a computer system, the computer system comprising at least one server computing device in communication with at least one client computing device across a telecommunications network, the method comprising operating said computer system to:
store data defining at least one category hierarchy, said at least one category hierarchy comprising a top level and at least one subordinate level including a lowest level, said top level including a top level hierarchy element corresponding to a main category topic, said at least one subordinate level including at least one respective subordinate hierarchy element corresponding to a respective sub-category topic, and wherein said lowest level includes at least one subordinate element corresponding to a respective one of a plurality of question categories;
assign each of said questions to at least one of said question categories;
maintain, in respect of said at least one question categories, at least one set of at least one of said questions assigned to the respective question category;
present, at said at least one client computing device, a user interface providing an interactive representation of said at least one category hierarchy;
record, at said at least one client computing device, path data indicative of a path taken by a player through a selected one of said at least one category hierarchy using said interactive representation and said user interface;
maintain, in respect of said at least one player, a play history record including said path data and data indicating the number of times said at least one player has selected each of said question categories;
analyse, in respect of said at least one player, the respective play history record to detect at least one pattern in said at least one player's interaction with the system;
determine, in respect of said at least one player, at least one predicted next question category using said at least one pattern; and
compare, in respect of said at least one predicted next question category, the respective play history record for the respective player and said at least one set of questions assigned to the respective question category to determine a demand for questions in the respective question category.

2. The method of claim 1, wherein at least some of said questions are assigned to a plurality of said question categories.

3. The method of claim 1, wherein at least some of said questions are assigned to at least one of said question categories so that said at least some of said questions are associated with a plurality of said subordinate elements of at least one of said category hierarchies.

4. The method of claim 3, wherein said plurality of subordinate elements belong to said lowest level in the respective category hierarchy.

5. The method of claim 1, wherein at least some of said question categories are selectable, by said player using said interactive representation and said user interface, by any one of a plurality of said paths through at least one of the or each category hierarchy.

6. The method of claim 1, wherein said at least one player comprises a plurality of players, said method further including determining either or both of the number or percentage of said players selecting said at least one predicted next question category.

7. The method of claim 1, wherein said at least one player comprises a plurality of players, said method further including determining either or both of the number or percentage of said players selecting said main category topic.

8. The method of claim 1, wherein said at least one player comprises a plurality of players, said method further including determining either or both of the number or percentage of said players selecting said at least one subordinate category topic.

9. The method of claim 1, wherein said at least one player comprises a plurality of players, said method further including determining either or both of the number or percentage of said players repeatedly selecting said at least one predicted next question category.

10. The method of claim 1, wherein said at least one player comprises a plurality of players, said method further including determining either or both of the number or percentage of said players repeatedly selecting said main category topic.

11. The method of claim 1, wherein said at least one player comprises a plurality of players, said method further including determining either or both of the number or percentage of said players repeatedly selecting said at least one subordinate category topic.

12. The method of claim 1, including defining said at least one hierarchy so that at least one player selectable path through at least two of said at least one category hierarchies includes at least one sequence of at least two of said topics.

13. The method of claim 12, including defining said at least one hierarchy so that at least one player selectable path through at least two of said at least one category hierarchies includes at least one reverse sequence of said at least two of said topics.

14. The method of claim 1, including defining said at least one hierarchy so that at least two player selectable paths through at least one of said at least one category hierarchies includes at least one sequence of at least two of said topics.

15. The method of claim 14, including defining said at least one hierarchy so that at least two player selectable paths through at least one of said at least one category hierarchies includes at least one reverse sequence of said at least two of said topics.

16. The method of claim 1, wherein said at least one player comprises a plurality of players, and wherein determining said demand for questions is performed by analysing the respective play history of each of said players.

17. The method of claim 1, wherein said analysing the respective play history record to detect at least one pattern involves detecting, in at least one of said paths, repeated sequences of two or more topics or types of topics.

18. The method of claim 1, wherein said analysing the respective play history record to detect at least one pattern involves detecting, in at least one of said paths, relationships between two or more topics, or types of topic.

19. The method of claim 1, wherein said analysing the respective play history record to detect at least one pattern involves detecting, in at least one of said paths, repeated selection of any one of said subordinate category topics after different category topics associated with a superior level in the respective category hierarchy.

20. A computer system for managing a computer-implemented quiz in which questions are delivered to at least one player, the computer system comprising at least one server computing device in communication with at least one client computing device across a telecommunications network, the system including computer software configured to operate said computer system to:
store data defining at least one category hierarchy, said at least one category hierarchy comprising a top level and at least one subordinate level including a lowest level, said top level including a top level hierarchy element corresponding to a main category topic, said at least one subordinate level including at least one respective subordinate hierarchy element corresponding to a respective sub-category topic, and wherein said lowest level includes at least one subordinate element corresponding to a respective one of a plurality of question categories;
assign each of said questions to at least one of said question categories;
maintain, in respect of said at least one question categories, at least one set of at least one of said questions assigned to the respective question category;
present, at said at least one client computing device, a user interface providing an interactive representation of said at least one category hierarchy;
record, at said at least one client computing device, path data indicative of a path taken by a player through a selected one of said at least one category hierarchy using said interactive representation and said user interface;
maintain, in respect of said at least one player, a play history record including said path data and data indicating the number of times said at least one player has selected each of said question categories;
analyse, in respect of said at least one player, the respective play history record to detect at least one pattern in said at least one player's interaction with the system;
determine, in respect of said at least one player, at least one predicted next question category using said at least one pattern; and
compare, in respect of said at least one predicted next question category, the respective play history record for the respective player and said at least one set of questions assigned to the respective question category to determine a demand for questions in the respective question category.
